(19) United States
(12) Patent Application Publication
(10) Pub. No.: US 2003/0038528 A1
(43) Pub. Date: Feb. 27, 2003

(54) Pocket wheel cover for portable golf cart

(76) Inventor: Youngi Kim, Fountain Valley, CA (US)

Correspondence Address: Eugene Oak, Ph.D., Patent Attorney, 610 S. Van Ness Ave., Los Angeles, CA, 90005, US

(21) Appl. No.: 10/270,215

(22) Filed: Oct. 15, 2002

Related U.S. Application Data
(63) Continuation-in-part of application No. 09/643,241, filed on Aug. 22, 2000, now abandoned.

(51) Int. Cl. B60B 7/00

(52) U.S. Cl. 301/37.101

(57) ABSTRACT

A novel wheel cover for a portable golf cart is comprised of a solid planar plastic disc, a flexible vinyl envelope cover, an elastic rubber band, a flexible pocket, and a zip. The solid planar plastic disc is attached to the center of the flexible vinyl envelope cover by hot melt adhesion. The flexible pocket for small items such as a golf tee, scoring pencil and golf gloves is attached on the surface of the solid planar plastic disc by hot melt adhesion. The zip secures the opening of the pocket. The elastic rubber band is annularly secured in a rim portion of an opening portion of the flexible envelope. The materials of construction for novel wheel cover are, including but not limited to, m-HDPE (metallocene catalyst polymerized high density polyethylene) molding grade and m-LLDPE (metallocene catalyst polymerized linear low density polyethylene) film grade, which are easily adhered to each other by a heat sealing. The wheel cover of this invention is to protect indoor environments such as the inside of an automobile trunk, garage and inside of a house from contamination by dirts, leaves of grass, and moisture, which were attached to the golf cart wheel.

This invention is a continuation in part of the previous U.S. patent application Ser. No. 09/643,241, which is now abandoned.

### BACKGROUND OF THE INVENTION

Most of the golf players carry their clubs in a portable golf cart. They like to bring the golf cart in the middle of the field. Then small chips of the fresh cut grasses, dry fallen leaves, wet soil of the field and sometimes excrements of animals living in the golf course area are attached to the wheels of the cart. Such contaminates fall and accumulated in the trunk box of the player's car when dried and the car is in motion. Since the inside of the most of car's trunk box is covered with carpet like material, it is very hard to remove such small sticky dirts even with a strong vacuum. It is purpose of this invention to provide an economical and convenient means to protect a car trunk box and other indoor environments from the dirts attached during golfing.

1. Field of the Invention

The novel golf cartwheel cover is comprised of a vinyl cap and rigid outer plate on which a pocket for small itemss for golfing is attached.

2. Description of the Prior Arts

U.S. Pat. No. 6,116,415 to Rastelli illustrates a tire and wheel cover with one size to expand over many size tires and wheels. Two sections of covering material are used, a detachable center section for viewing the wheel and a wide circumferential section of material for covering the tire. The two sections being removably attached to each other allowing for viewing of the wheel. The circumferential section of material rear side having a hollow enfold with an elastic cord inside.

U.S. Pat. No. 5,996,863 to Burke illustrate a decorative tire cover which is defined by a flexible tire cover having a first circular opening formed in one side thereof for enabling a photograph or artwork situated inside thereof to be visible to someone outside the flexible tire cover. An opposing side of the flexible tire cover has a second circular opening formed therein enabling the flexible tire cover to be wrapped around a spare tire.

U.S. Pat. No. 4,844,005 to Filomeno illustrates a tire protection cover from paints while the automobile is body spray-painted. The device is a shell that covers the tire to block paint spray, and the shell is further provided with pivotal chocks for wheel rolling prevention. In one embodiment a pocket secured to the shell also provides for the placement of work sheets, etc. In another embodiment the tire protection cover comprises a thin flexible sheet of plastic material having an annular elastic band fixedly secured in a rim portion.

U.S. Pat. No. 4,214,683 to Wills, et al. introduces an illuminating spare tire cover comprised of a light transmitting solid member and a flexible side cover tightened by a elastic material like spring and band.

U.S. Pat. 2,072,490 to Whalet demonstrates an advertising sign holder for spare tire. The holder is consisted of a face member made of canvas, a stiffening member, an annular flexible cover member and a ring like member for fastening the cover member to a tire.

U.S. Pat. No. 1,704,555 to Cluff illustrates an emblem disk attachable spare tire cover.

U.S. Pat. No. 1,495,665 to Bigelow et al teaches a tire cover made of imitation leather, leather, canvas. A coiled spring is used for tensioning the cover surface.

All of the prior arts illustrate a tire cover for automobiles. One kind is to decorate a spare tire and the other is to protect the tires from the outside contaminations. None of the prior arts illustrates a portable golf cartwheel cover, which protects the indoor environment from the dirt and grasses, which are attached on the golf cartwheel after use.

### SUMMARY OF THE INVENTION

A novel wheel cover for a portable golf cart is comprised of a solid planar plastic disc, a flexible vinyl envelope cover, an elastic rubber band, a flexible pocket, and a zip. The solid planar plastic disc is attached to the center of the flexible vinyl envelope cover by a hot melt adhesion. The flexible pocket for small items such as a golf tee, scoring pencil and golf gloves is attached on the surface of the solid planar plastic disc by a hot melt adhesion. The zip secures the opening of the pocket. The elastic rubber band is annularly secured in a rim portion of an opening of the flexible envelope. The planar plastic disc, the flexible pocket and the flexible cover are made of, including but not limited to, the same plastic of an m-HDPE (metallocene catalyst polymerized high density polyethylene) molding grade and m-LLDPE (metallocene catalyst polymerized linear low density polyethylene) film grade, which are easily adhered to each other by a heat sealing, polyvinyl chloride, polyurethane and natural fiber reinforced structure of them. The wheel cover of this invention is to protect indoor environments such as the inside of an automobile trunk, garage and inside of a house from contamination by dirts, leaves of grass, and moisture, which were attached to golf, cart wheel during golfing.

### BRIEF DESCRIPTION OF THE DRAWINGS

FIG. 1-a is a perspective view of the parts for the golf cartwheel cover of this invention.

FIG. 1-b is a perspective view of the golf cartwheel cover of this invention applied on a golf cartwheel.

FIG. 2 is a side view of the golf cartwheel cover of this invention applied on a golf cartwheel.

FIG. 3 is an inside view of the golf cartwheel cover of this invention applied on a golf cartwheel.

### DETAILED DESCRIPTION OF THE PREFERRED EMBODIMENTS

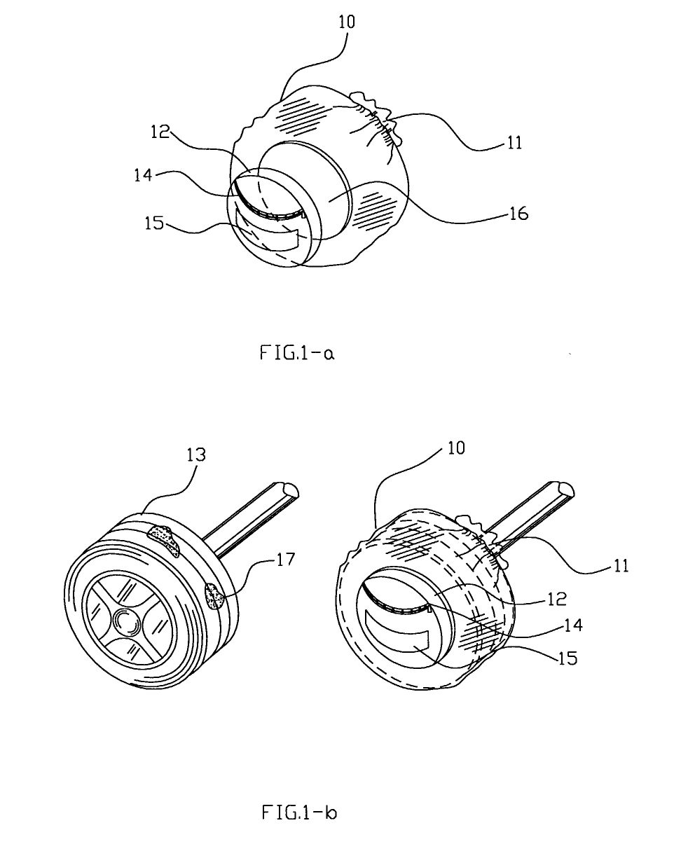

FIG. 1-a is a perspective view of the parts for the golf cartwheel cover of this invention. The portable golf cartwheel cover of this invention is comprised of a flexible vinyl cover (10), a solid plastic disc (16), a pocket (12) made of the same material for the cover (10) and the disc (16). The solid plastic disc (16) is attached to the center of the flexible cover (10) by a hot melt adhesion. The solid plastic protects the environments and carriers from being scratched by a projected wheel shaft. The pocket (12) is for containing small items for golfing such as a golf tee, scoring paper, scoring pencil, and even golf gloves. The pocket (12) is made of the similar material which is compatible with the vinyl cover and solid plastic disc, which enables a hot melt adhesion at one step. A zip (14) secured the opening of the pocket (12). The surface of the pocket is decorated with a logo (15). The other side of the cover (10) is secured by an elastic rubber band (11). The material for this invention is, including but not limited to, an m-HDPE (metallocene catalyst polymerized high density poly-ethylene) molding grade and m-LLDPE (metallocene catalyst polymerized linear low density polyethylene) film grade. These materials are of one family of polymers, which are easily adhering to each other by a heat sealing.

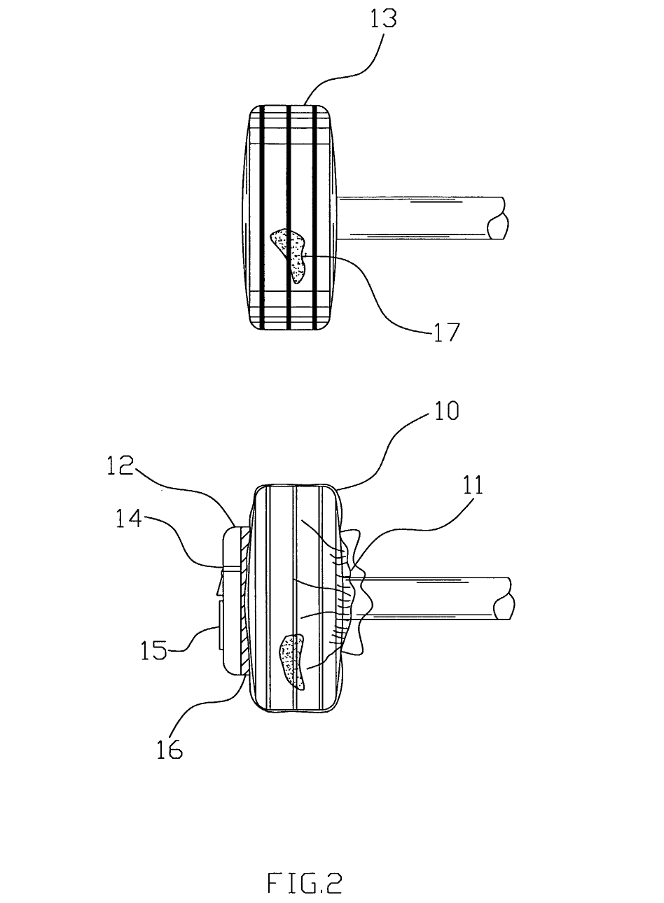

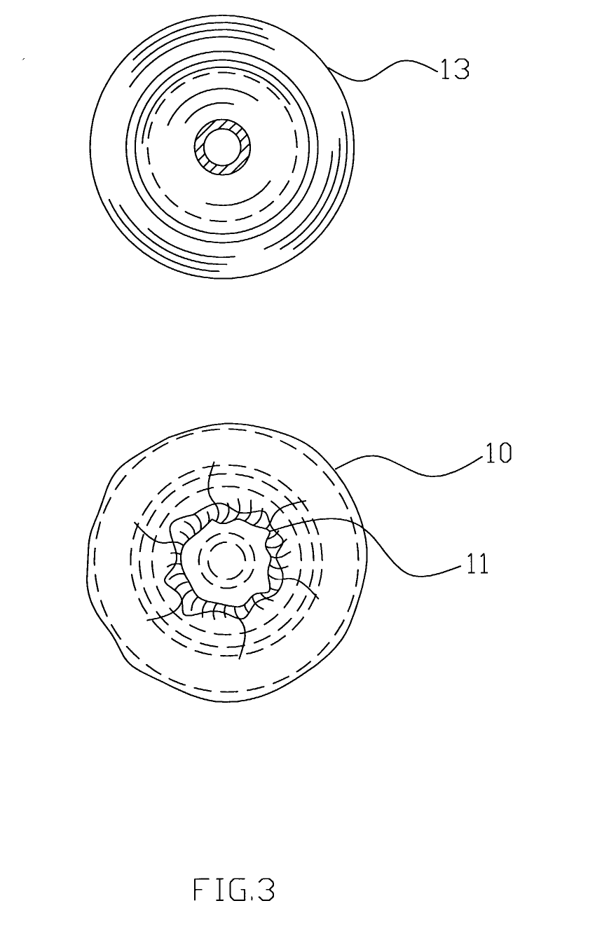

FIG. 1-b is a perspective view, FIG. 2 is a side view and FIG. 3 is an inside view of the golf cartwheel cover of this invention applied on a golf cartwheel. When the cover of this invention is applied on a golf cartwheel (13), the flexible cover (10) wraps the whole wheel (13) to the rear of the wheel and retains the dirt (17) inside of the cover to provide clean appearance.

The best mode of this invention is to make the wheel cover out of the metallocene HDPE for the solid plate (16), metallocene LLDPE for flexible cover (10) and metallocene MDPE (medium density polyethylene) for the pocket (12) to adhere them at once by a heat sealing.

What is claimed is

1. A novel wheel cover for a portable golf cart is comprised of a solid planar plastic disc, attached to the center of the flexible vinyl envelope cover by a hot melt adhesion, a flexible vinyl envelope cover of which the opening is secured by an elastic rubber band, annularly secured in a rim portion of the flexible envelope's opening, and a flexible pocket, attached on the surface of the solid planar plastic disc by hot melt adhesion, of which the opening is secured by a zip.

2. The outer surface of the flexible pocket, in claim 1, is decorated with a logo.

3. The material for the solid planar disc, in claim 1, is m-HDPE (metallocene catalyst polymerized high density polyethylene) molding grade.

4. The material for the flexible pocket, in claim 1, is m-LLDPE (metallocene catalyst polymerized linear low density polyethylene) film grade.

5. The material for a flexible vinyl envelope cover, in claim 1, is m-LLDPE film grade.

6. The solid planar plastic disc, the flexible vinyl envelope cover, and the flexible pocket, in claim 1, are adhered to each other by a heat sealing method at one step at the temperatures between 90 to 110°.

7. The wheel cover, in claim 1, retains the dirt from the game within to prevent contamination of trunk box of a car.
